(19) United States
(12) Patent Application Publication
(10) Pub. No.: US 2006/0187217 A1
(43) Pub. Date: Aug. 24, 2006

(54) Automatic changing system of standby screen and method thereof

(76) Inventors: Dae Ik Son, Seoul (KR); Won Ki Kim, Seoul (KR); Ho Sung Ha, Seoul (KR)

Correspondence Address: QUARLES & BRADY LLP, 411 E. WISCONSIN AVENUE, SUITE 2040, MILWAUKEE, WI, 53202-4497, US

(21) Appl. No.: 11/353,775

(22) Filed: Feb. 14, 2006

(30) Foreign Application Priority Data
Feb. 15, 2005 (KR) 10-2005-0012495

(51) Int. Cl. G09G 5/00

(52) U.S. Cl. 345/204

(57) ABSTRACT

Disclosed is an automatic changing system of standby screen and method thereof that automatically change a standby screen of a mobile terminal corresponding to position information of the user and the number of times the folder has been opened/closed by the user and thus provide required information in accordance with a specific condition of a client in time. The system includes an LBS system for conforming position information of a user, generating a position code corresponding to the position information and then outputting the same; a position information and folder state management unit for storing and managing the number of times the folder has been opened/closed counted during a predetermined time; a VM and contents management system for receiving the position code from the LBS system, outputting a corresponding standby screen VM or contents by comparing the position code and an index of a standby VM list or contents and then detecting whether corresponding standby screen (or contents) is installed at a mobile terminal or storing and managing corresponding standby screen VM or contents in accordance with the number of times the folder has been opened/closed through a counting program embedded in the mobile terminal, and outputting corresponding standby screen VM or contents in the case that the number of times the folder has been opened/closed exceeds a predetermined number; and a standby screen provision system for receiving corresponding standby screen VM or contents from the VM and contents management system, and then providing the mobile terminal with corresponding standby screen VM or contents so as to change previous standby screen VM or contents into corresponding standby screen VM or contents.

### BACKGROUND

1. Field of the Invention

The present invention relates to an automatic changing system of standby screen and method thereof, particularly to an automatic changing system of a standby screen and method thereof which automatically change the standby screen of a mobile terminal corresponding to position information of the user and the number of times the user opens/closes the folder and thus provide required information in accordance with the specific condition of a client in time.

2. Discussion of Related Art

Recently, the number of wireless internet users that use a mobile terminal has increased a lot, and a wireless internet service using a mobile terminal is provided with various menus as a tree structure by considering the constraints of display size.

That is, in order to utilize wireless internet, a user gets access to a wireless internet server, selects a menu that the user wants to use among various menus included on a portal page displayed on the screen of a mobile terminal and provided by a mobile communication service provider, and then selects a final page by selecting any one of the sub-menus of the selected menu. Regarding the above, because various menus are composed as a tree structure in the wireless internet service through a mobile terminal, the depth of a menu is deepened and a lot time is consumed using it and thus the service fee is increased. In addition, the problem will be compounded for a user who frequently uses wireless internet.

However, a user, who wants to utilize financial traffic information and performs transactions such as deposits and stock-related transactions without restriction of time and space, feels uncomfortable due to unnecessary service fees and uses wireless internet services grudgingly. Services therefor, which save wireless internet access time by updating contents of a standby screen periodically, are embodied.

But recently in the conventional art, there has been no service that changes into a virtual machine based standby screen according to predetermined information (for example, required information of an amusement park and real estate information of a specific area) on the basis of the location of a user.

### SUMMARY OF THE INVENTION

Accordingly, it is an object of the present invention to provide an automatic changing system of a standby screen and method thereof which automatically change a standby screen of a mobile terminal corresponding to position information of a user and the number of times the user opens/closes the folder and thus provide required information in accordance with a specific condition of a client at a certain time.

Therefore, according to the present invention, a standby screen of a mobile terminal, which is requested corresponding to specific conditions such as position of the user and the number of times the user opens/closes the folder, is automatically changed into, required information in accordance with a specific condition of a client is provided in time, and thus a user can be provided with convenience.

Accordingly, it is the first aspect of the present invention to provide an automatic changing system of a standby screen automatically changing a standby screen of a mobile terminal corresponding to and position information and the number of times the user opens/closes the folder by a user, the system comprising: an LBS system for conforming position information of a user, generating a position code corresponding to position information and then outputting the same; a position information and folder state management unit for storing and managing the number of times the user opens/closes the folder counted during a predetermined time; a VM(Virtual Machine) and contents management system for receiving the position code from the LBS system, outputting corresponding standby screen VM or contents by comparing the position code and an index of a standby VM list or contents and then detecting whether corresponding standby screen (or contents) is installed at a mobile terminal or storing and managing corresponding standby screen VM or contents in accordance with the number of times the folder has been opened/closed through a counting program embedded in the mobile terminal, and outputting corresponding standby screen VM or contents in the case that the number of times the folder has been opened/closed exceeds a predetermined number; and a standby screen provision system for receiving corresponding standby screen VM or contents from the VM and contents management system, and then providing the mobile terminal with corresponding standby screen VM or contents so as to change the previous standby screen VM or contents into the corresponding standby screen VM or contents.

Preferably, the changed standby screen VM or contents are transmitted to the mobile terminal in the form of a short message through a short message service center, and the generation of the short message is performed by transmitting an INVOKE parameter for driving a standby screen generated based on a virtual machine except for standby screen VM or contents.

More preferably, the period of the change can be selected by the user, or can be renewed every time assigned by the changing system of the standby screen in the case that the user does not select. Most preferably, the VM and contents management system comprises: a subscriber management unit for storing and managing user information of a mobile terminal so as to use an automatic changing service of a standby screen, and generating a new database in the case that a new subscriber accesses it; a standby screen and contents management unit for storing and managing various kinds of standby screen VM and contents information provided from a plurality of CP servers at the database, renewing the database in the case that new standby screen VM and contents information are added, deleted or changed; a position information and folder state management unit for receiving a position information related code of the mobile terminal realized during an adjusted time or by a user's request from an LBS system, simultaneously receiving the number of times the folder has been opened/closed from a mobile terminal, and storing the same together with the code at the database; and a changing condition management unit for adjusting the condition for changing a standby screen VM and contents in accordance with the position information of the user or the number of times the folder has been opened/closed by the mobile terminal user, and storing the adjusted conditions in the database.

In the embodiment, the changing condition management unit enables a user to select the changing condition of the standby screen and contents in accordance with the position of the mobile terminal and the number of times the folder(flip) has been opened/closed, and manage the changing condition. Further, the automatic changing system of standby screen is driven by being embedded inside of a predetermined server of a service provider, or is embodied by being embedded as an internal program of a mobile terminal.

According to the second aspect of the present invention, there is provided an automatic changing method of standby screen automatically changing a standby screen of a mobile terminal corresponding to and position information and the number of times the folder has been opened/closed by the user, the method comprising the steps of: (A) a changing condition management unit enabling the user to select the condition as to whether corresponding standby screen VM and contents in accordance with the position of the mobile terminal are provided to the user and storing the changing condition in a database; (B) an LBS system confirming position information of the mobile terminal, generating a position code related to the position information, outputting the same to an automatic changing system of a standby screen, and a changing condition management unit of the automatic changing system of a standby screen comparing the position and an index of a standby screen VM list pre-stored in a database; and (C) the changing condition management unit changing into corresponding standby screen VM and then servicing by transmitting an INVOKE parameter for driving a virtual machine based standby screen to the mobile terminal through a standby screen provision system and a short message service center in the case that an index of a standby screen VM list corresponding to the position code exists, as the comparison result of the step (B).

Preferably, the step (C) comprises the steps of: (C-1) the changing condition management unit inquiring of a user whether to download a corresponding standby screen VM through the database in the case that an index of a standby screen VM list corresponding to the position code does not exist, as the comparison result of the step (B).

According to the third aspect of the present invention, there is provided an automatic changing method of a standby screen automatically changing a standby screen of a mobile terminal corresponding to position information and the number of times the folder has been opened/closed by a user, the method comprising the steps of: (a) a changing condition management unit adjusting contents changing condition in accordance with the number of times the folder of the mobile terminal has been opened/closed, and then storing the adjusted condition in a database; (b) the mobile terminal performing an embedded counting program in the case that a user selects the changing condition of contents displayed on a standby screen; (c) a position information and folder state management unit managing the counted number of times the folder has been opened/closed, and transmitting a standby screen in accordance with the counted number of times the folder has been opened/closed to the changing condition management unit; and (d) driving a standby screen VM in the case that a user opens a folder of the mobile terminal at a predetermined point, the changing condition management unit discriminating the number of times the folder has been opened/closed counted until the predetermined point and then outputting corresponding standby screen and contents to a standby screen provision system, and the standby screen provision system providing the mobile terminal with the same through a mobile communication system.

Preferably, the changing condition management unit enables a user to select the changing condition of the standby screen and contents in accordance with the position of the mobile terminal and the number of times the folder (flip) has been opened/closed and managing the changing condition, and the changing condition is performed by unilaterally providing contents in accordance with a predetermined number of times the folder has been opened/closed by the discrimination of the changing condition management with the mobile terminal and displaying the same on the screen of the mobile terminal without the user's selection.

### BRIEF DESCRIPTION OF THE DRAWINGS

These and/or other aspects and advantages of the invention will become apparent and more readily appreciated from the following description of the preferred embodiments, taken in conjunction with the accompanying drawings of which:

FIG. 1 illustrates an exemplary embodiment of an automatic changing system of a standby screen in accordance with the present invention;

FIG. 2 illustrates a detailed diagram of the VM and contents management system of FIG. 1;

FIG. 3 illustrates a flow chart of an automatic changing method of a standby screen in accordance with one exemplary embodiment of the present invention; and

FIG. 4 illustrates a flow chart of an automatic changing method of a standby screen in accordance with another exemplary embodiment of the present invention.

The following Examples are given for the purpose of illustration only and are not intended to limit the scope of this invention.

### DETAILED DESCRIPTION OF PREFERRED EMBODIMENTS

Hereinafter, preferable embodiments according to the present invention will be described with reference to the accompanying drawings. Here, when one element is connected to another element, one element may be not only directly connected to another element but also indirectly connected to another element via a third element. Further, irrelevant elements are omitted for clarity. Also, like reference numerals refer to like elements throughout.

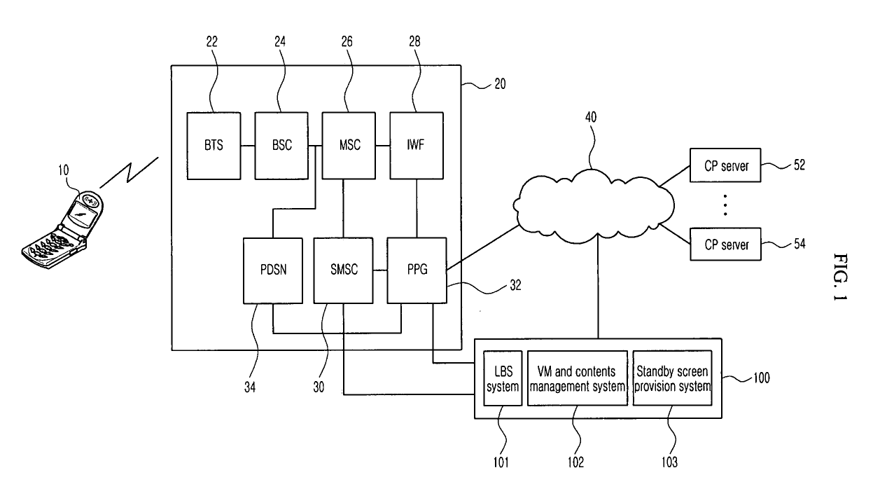

Referring to FIGS. 1 through 4, a preferable embodiment that is easily embodied by a person having ordinary skill in the same art that the present invention belongs to will be described in more detail.

FIG. 1 illustrates an exemplary embodiment of an automatic changing system of a standby screen in accordance with the present invention.

As depicted in FIG. 1, an automatic changing system of a standby screen 100 in accordance with the present invention is connected with a plurality of mobile terminals 10 through a mobile communication system 20. The mobile communication system 20 is connected with a plurality of CP servers (52, 54) through an IP network 40, collects various standby screen VMs and contents, and provides with a standby screen VM and contents to the mobile terminal 10 which wishes to be connected to a wireless internet.

The automatic changing system of a standby screen 100 comprises an LBS system 101 for being connected with a plurality of CP severs (52, 54), being connected with the mobile terminal user and the mobile communication system 20 and the IP network 40, confirming position information of the user mobile terminal 10, generating a position code corresponding to the position information and then outputting the same; a VM and contents management system 102 for receiving the position code from the LBS system 101, outputting corresponding standby screen VM or contents by comparing the position code and an index of a standby VM list or contents and then detecting whether corresponding standby screen (or contents) is installed at the mobile terminal 10; and a standby screen provision system 103 for receiving the corresponding standby screen VM or contents from the VM and contents management system 102 and then providing the mobile terminal 10 with the corresponding standby screen VM or contents so as to change the previous standby screen VM or contents into the corresponding standby screen VM or contents.

In addition, the automatic changing system of the standby screen 100 comprises a VM and contents management system 102 for storing and managing corresponding standby screen VM or contents in accordance with the number of times the folder (flip) has been opened/closed through a counting program embedded in the mobile terminal, and outputting corresponding standby screen VM or contents in the case that the number of times the folder has been opened/closed exceeds a predetermined number; and a standby screen provision system 103 for receiving corresponding standby screen VM or contents from the VM and contents management system 102 and then providing the mobile terminal 10 with corresponding standby screen VM or contents through the mobile communication system 20.

Herein, the mobile communication system 20 comprises a BTS 22 for wireless-communicating with the mobile terminal 10, a BSC 24 for controlling the BTS 22, an MSC 26 for performing the call exchange by being connected with at least one of the BSC 24, an inter-working function unit 28 for mutual format change between a voice data and a packet data, an SMSC 30 for performing the transmission/reception to/from the MSC 26, a push proxy gateway 32 form performing the message push to the mobile terminal 10, and a PDSN (packet data service node; 34).

The changed standby screen VM or contents is transmitted to the mobile terminal 10 in the form of a short message through an SMSC (short message service center; 30), and the short message includes an INVOKE parameter for driving a standby screen generated based on a virtual machine except for the standby screen VM or contents. In addition, the period of change can be selected by the user or can be renewed every times assigned by the changing system of the standby screen in the case that a user does not select.

In the structure of the communication network, the automatic changing system of a standby screen 100 can be driven by being embedded inside of a predetermined server of a service provider, or be embodied by being embedded as an internal program of the mobile terminal 10.

Additionally, the automatic changing system of a standby screen 100 can display personal contents on a standby screen as well as a standby screen and contents provided from the CP server (52, 54). For example, the user can adjust information videotaped by a camera mounted in a predetermined area and information related to the bulletin which a user operates and is affiliated with as a standby screen and contents, updates the pieces of information, and can provide the standby screen provision system 103 with the same through mobile terminal 10.

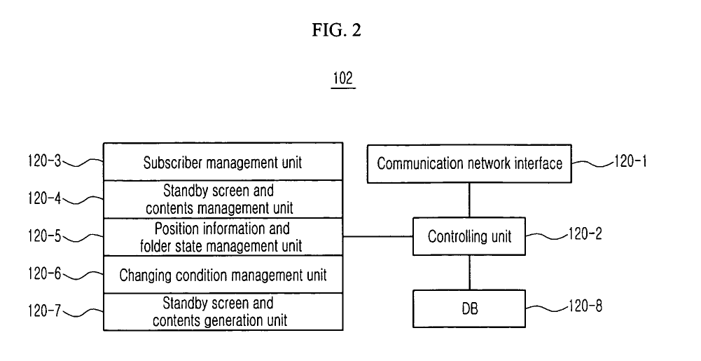

FIG. 2 illustrates a detailed diagram of a VM and contents management system of FIG. 1.

As depicted in FIG. 2, the VM and contents management system 102 comprises a communication network interface 102-1 for performing the communication with the CP server (52, 54); a controlling unit 102-1; a subscriber management unit 102-3; a standby screen and contents management unit 102-4; a position information and folder state management unit 102-6; a changing condition management unit 102-6; a standby screen and contents generation unit; and a database 102-8.

The subscriber management unit 102-3 stores and manages user information of a mobile terminal in the database 102-8 so as to use the automatic changing service of the standby screen provided from the standby screen provision system 100, and generating a new database in the case that a new subscriber accesses it. A user gets access to the VM and contents management system 102 through a non-wireless or wireless internet, and applies for and utilizes the service thereof.

The standby screen and contents management unit 102-4 stores and manages various kinds of standby screen VM and contents information provided from a plurality of CP servers (52, 54) at the database 102-8, and renews the database 102-8 in the case that new standby screen VM and contents information are added, deleted and changed.

For example, the standby screen VM or contents provided in accordance with the number of times the folder (or flip) has been opened/closed can include mail, agenda alarm, investment chart, financial information (bank, stock, etc), stock information (various indexes, stock market prices of issues of interest, issue charts, posted prices of issues of interest, recommended issues), real estate information (news and stock market prices for an area of interest), loans information (loan interest rates, payment information), card information (approval of cases, mileage), news, etc.

The position information and folder state management unit 102-5 receives a position information related code of the mobile terminal 10 realized during an adjusted time or by a user's request from an LBS system 101, simultaneously receives the number of times the folder has been opened/closed from the mobile terminal 10, and stores the same together with the code at the database 102-8.

The changing condition management unit 102-6 adjusts the condition for changing a standby screen VM and contents in accordance with position information or the number of times the folder has been opened/closed by the mobile terminal user, and stores the adjusted condition at the database. Namely, the changing condition management unit 102-6 enables a user to select the changing condition of a standby screen and contents in accordance with the position of the mobile terminal 10 and the number of times the folder (flip) has been opened/closed and manages the changing condition.

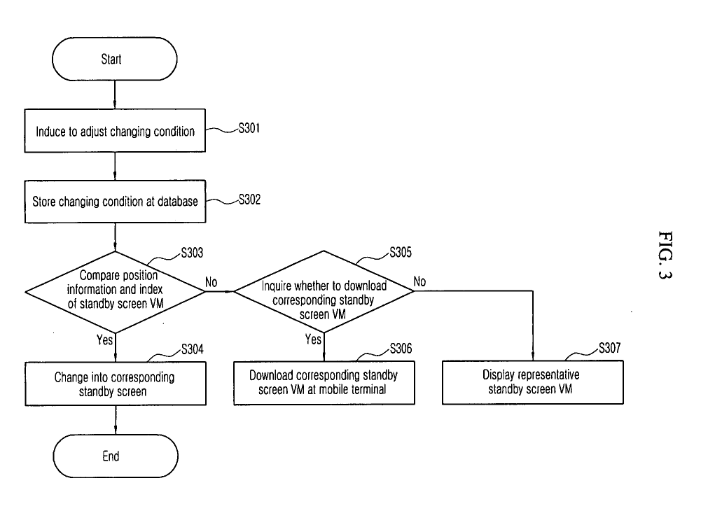

FIG. 3 illustrates a flow chart of an automatic changing method of a standby screen in accordance with one exemplary embodiment of the present invention.

Hereinafter, a series of method how the automatic changing system of the standby screen 100 automatically downloads a standby screen VM and contents corresponding to a predetermined area will be explained in the case that the mobile terminal user is located on the predetermined area. Of course, in case of the above, the user can be provided with a standby screen list or contents list corresponding to predetermined area information from the automatic changing system of the standby screen 100 and can select the same previously before the user receives the service.

The changing condition management unit 102-6 enables the user to select the condition as to whether corresponding standby screen VM and contents in accordance with the position of the mobile terminal 10 are provided to the user, and stores the changing condition at the database 102-8 (S302).

After that, the LBS system 101 confirms the position information of the mobile terminal 10, generates a position code related to the position information and outputs the same to the automatic changing system of the standby screen 100, and the changing condition management unit 102-6 of the automatic changing system of the standby screen 100 compares the position and an index of a standby screen VM list pre-stored in the database 102-8 (S303)

In the comparison result of the step (S303), the changing condition management unit 102-6 changes into corresponding standby screen VM and then servicing by transmitting an INVOKE parameter for driving a virtual machine based standby screen to the mobile terminal 10 through a standby screen provision system 103 and a short message service center 30 in the case that an index of the standby screen VM list corresponding to the position code exists (S304). For example, in the case that the mobile terminal user is located on an amusement park, the VM of the amusement park is operated so that a standby screen VM corresponding to the area in that the amusement park is located is serviced.

In the comparison result of the step (B), the changing condition management unit 102-6 inquires of a user whether to download corresponding standby screen VM through the database 102-8 in the case that an index of a standby screen VM list corresponding to the position code does not exist (S305).

In the inquiring result of the step (S305), the changing condition management unit 102-6 downloads corresponding standby screen VM through a standby screen provision system from the database 102-8 in the case that a user wants to download corresponding standby screen VM (S306).

On the other hand, in the inquiring result of the step (S305), the changing condition management unit 102-6 displays a pre-adjusted representative standby screen VM to the mobile terminal 10 in the case that a user does not want to download corresponding standby screen VM (S307).

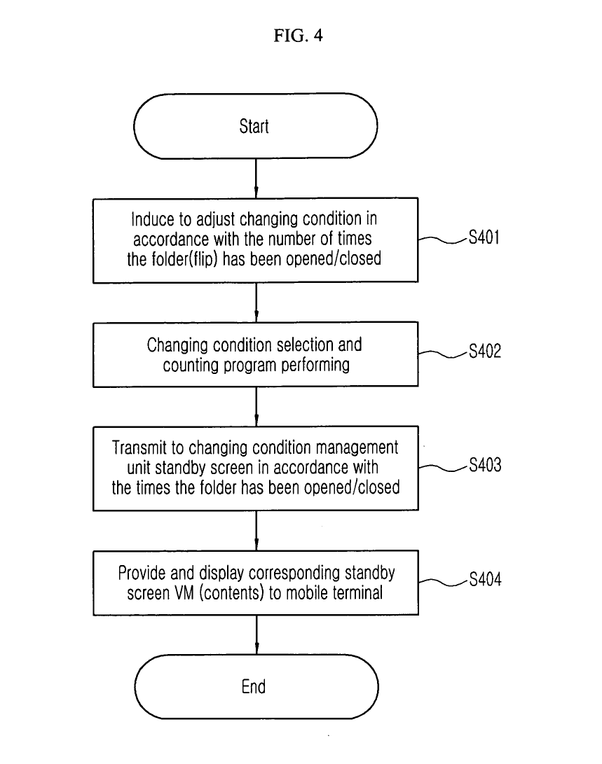

FIG. 4 illustrates a flow chart of an automatic changing method of a standby screen in accordance with another exemplary embodiment of the present invention.

Hereinafter, a series of method how a standby screen pre-adjusted in accordance with a number of open/close of a folder of a user is automatically changed will be explained in a specific standby screen VM of the mobile terminal 10. In case of above, a user can be provide with contents list corresponding to the number of times the folder (or flip) has been opened/closed from the automatic changing system of the standby screen 100 and select the same previously before the user receives the service.

The changing condition management unit 102-6 adjusts the contents changing condition in accordance with the number of times the folder or flip of the mobile terminal 10 has been opened/closed, and then stores the adjusted condition in the database 102-8 (S401). That is, the changing condition management unit 102-6 enables a user to select the changing condition of the standby screen and contents in accordance with the position of the mobile terminal 10 and the number of times the folder (flip) has been opened/closed and manages the changing condition, and the changing condition is performed by unilaterally providing contents in accordance with a predetermined number of times the folder has been opened/closed by the discrimination of the changing condition management with the mobile terminal and displaying the same on the screen of the mobile terminal without the user's selection.

The mobile terminal 10 performs an embedded counting program in the case that a user selects the changing condition of contents displayed on the standby screen, and the position information and folder state management unit 102-5 receives the counted the number of times the folder has been opened/closed and manages a counted number of open/close of a folder, and then a standby screen in accordance with the counted number of the folder has been opened/closed is transmitted to the changing condition management unit 102-6 (S403).

A standby screen VM is driven in the case that a user opens the folder of the mobile terminal 10 at a predetermined point, the changing condition management unit 102-6 discriminates the number of times the folder has been opened/closed, counted until the predetermined point and then outputs corresponding standby screen and contents to a standby screen provision system 103, and the standby screen provision system 103 provides the mobile terminal 10 with the same through a mobile communication system 20 (S404).

Herein, a standby screen is not changed in accordance with the discrimination of the number of times the folder has been opened/closed of the changing condition management unit 102-6, but changed by a predetermined controlling unit (not shown) of the mobile terminal 10 in accordance with the number of times the folder has been opened/closed after the mobile terminal 10 stores the result value (the number of times the folder has been opened/closed) of the counting program at a predetermined memory (not shown) in real time.

As an example of the automatic changing of the mobile terminal standby screen in accordance with the number of times the folder has been opened/closed, the standby screen to be changed can be embodied as an agenda standby screen in the case that the number of times the folder has been opened/closed is one, a stock standby screen in case it is two, a real estate standby screen in case it is three, etc.

As described above, according to the present invention, the standby screen of the mobile terminal is automatically changed corresponding to the position information of a user and the number of times the folder has been opened/closed by the user and thus the required information in accordance with a specific condition of a client can be provided in time.

In addition, according to the present invention, a standby screen of the mobile terminal, which is requested corresponding to specific conditions such as position of a user and the number of times the folder has been opened/closed by the user, is automatically changed into, required information in accordance with a specific condition of a client is provided in time, and thus the user can be provided with convenience.

Although a few embodiments of the present invention have been shown and described, it would be appreciated by those skilled in the art that changes might be made in this embodiment without departing from the principles and spirit of the invention, the scope of which is defined in the claims and their equivalents.

What is claimed is:

1. An automatic changing system of standby screen automatically changing a standby screen of a mobile terminal corresponding to position information and a number of times a folder has been opened/closed by a user, the system comprising:
an LBS system for conforming position information of the user, generating a position code corresponding to the position information and then outputting the position code;
a position information and folder state management unit for storing and managing the number of times the folder has been opened/closed, counted during a predetermined time;
a VM and contents management system for receiving the position code from the LBS system, outputting corresponding standby screen VM or contents by comparing the position code and an index of a standby VM list or contents and then detecting whether corresponding standby screen (or contents) is installed at a mobile terminal or storing and managing corresponding standby screen VM or contents in accordance with the number of times the folder has been opened/closed through a counting program embedded in the mobile terminal, and outputting corresponding standby screen VM or contents in the case that the number of times the folder has been opened/closed exceeds a predetermined number; and
a standby screen provision system for receiving corresponding standby screen VM or contents from the VM and contents management system, and then providing the mobile terminal with corresponding standby screen VM or contents so as to change the previous standby screen VM or contents into the corresponding standby screen VM or contents.

2. The system as claimed in claim 1, wherein the changed standby screen VM or contents is transmitted to the mobile terminal in the form of a short message through a short message service center, and the generation of the short message is performed by transmitting an INVOKE parameter for driving a standby screen generated based on a virtual machine except for the standby screen VM or contents.

3. The system as claimed in claim 2, wherein a period of the change can be selected by a user or can be renewed every times assigned by the changing system of the standby screen in the case that a user does not select it.

4. The system as claimed in claim 1, wherein the VM and contents management system comprises:
a subscriber management unit for storing and managing user information of a mobile terminal so as to use the automatic changing service of the standby screen, and generating a new database in the case that a new subscriber accesses it;
a standby screen and contents management unit for storing and managing various kinds of standby screen VM and contents information provided from a plurality of CP servers in the database, renewing the database in the case that new standby screen VM and contents information are added, deleted and changed;
a position information and folder state management unit for receiving a position information related code of the mobile terminal realized during an adjusted time or by a user's request from an LBS system, simultaneously receiving the number of times the folder has been opened/closed from a mobile terminal, and storing the same together with the code in the database; and
a changing condition management unit for adjusting the condition for changing a standby screen VM and contents in accordance with the position information or the number of times the folder has been opened/closed by the mobile terminal user, and storing the adjusted condition in the database.

5. The system as claimed in claim 4, wherein the changing condition management unit enables the user to select the changing condition of the standby screen and contents in accordance with the position of the mobile terminal and the number of times the folder (flip) has been opened/closed, and manages the changing condition.

6. The system as claimed in any of claims 1 through 5, wherein the automatic changing system of a standby screen is driven by being embedded inside of a predetermined server of a service provider, or is embodied by being embedded as an internal program of a mobile terminal.

7. An automatic changing method of a standby screen automatically changing a standby screen of a mobile terminal corresponding to position information and a number of times a folder has been open/close by a user, the method comprising the steps of:
(A) a changing condition management unit enabling a user to select the condition as to whether corresponding standby screen VM and contents in accordance with a position of the mobile terminal are provided to the user and storing the changing condition in a database;
(B) an LBS system confirming the position information of the mobile terminal, generating a position code related to the position information, outputting the position code to an automatic changing system of a standby screen, and the changing condition management unit of the automatic changing system of the standby screen comparing the position code and an index of a standby screen VM list pre-stored in a database; and
(C) the changing condition management unit changing into the corresponding standby screen VM and then servicing by transmitting an INVOKE parameter for driving a virtual machine based standby screen to the mobile terminal through a standby screen provision system and a short message service center in the case that an index of a standby screen VM list corresponding to the position code exists, as the comparison result of step (B).

8. The method as claimed in claim 7, wherein the step (C) comprises the step of:
(C-1) the changing condition management unit inquiring of the user whether to download the corresponding standby screen VM through the database in the case that an index of a standby screen VM list corresponding to the position code does not exist, as the comparison result of the step (B).

9. The method as claimed in claim 8, wherein the step (C-1) comprises the steps of:
C-1-1) the changing condition management unit downloading corresponding standby screen VM through a standby screen provision system from the database in the case that a user wants to download the corresponding standby screen VM, as the inquiring result of step (C-1); and
C-1-2) displaying a pre-adjusted representative standby screen VM to the mobile terminal in the case that a user does not want to download the corresponding standby screen VM, as the inquiring result of the step (C-1).

10. An automatic changing method of standby screen automatically changing a standby screen of a mobile terminal corresponding to and position information and a number of times a folder (or flip) a mobile terminal has been opened/closed by a user, the method comprising the steps of:
(a) a changing condition management unit adjusting contents changing condition in accordance with the number of times the folder (or flip) has been opened/closed, and then storing an adjusted condition in a database;
(b) the mobile terminal performing an embedded counting program in the case that the user selects the changing condition of contents displayed on the standby screen;
(c) a position information and folder state management unit managing a counted number of times the folder (or flip) has been opened/closed, and transmitting a standby screen in accordance with the counted number of times the folder (or flip) has been opened/closed to the changing condition management unit; and
(d) driving a standby screen VM in the case that the user opens the folder of the mobile terminal at a predetermined point, the changing condition management unit discriminating the number of times the folder (or flip) has been opened/closed, counted until the predetermined point and then outputting the corresponding standby screen or contents to a standby screen provision system, and the standby screen provision system providing the mobile terminal with the corresponding standby screen or contents through a mobile communication system.

11. The method as claimed in claim 10, wherein the changing condition management unit enables a user to select the changing condition of the standby screen and contents in accordance with a position of the mobile terminal and the number of times the folder (or flip) has been opened/closed and manages the changing condition, and the changing condition is performed by unilaterally providing contents in accordance with a predetermined number of open/close by the discrimination of the changing condition management with the mobile terminal and displaying the corresponding standby screen or contents on the screen of the mobile terminal without the user's selection.
